(19) United States
(12) Patent Application Publication
(10) Pub. No.: US 2023/0356506 A1
(43) Pub. Date: Nov. 9, 2023

(54) PRE-LAMINATED OPACIFYING ASSEMBLY FOR GLAZING

(71) Applicant: VISION SYSTEMS, Brignais (FR)

(72) Inventors: Georges FIGURA, Brignais (FR); Claire MONTET, Grigny (FR)

(21) Appl. No.: 17/786,393

(22) PCT Filed: Dec. 17, 2020
(86) PCT No.: PCT/EP2020/086819

§ 371 Date: Jun. 16, 2022

(30) Foreign Application Priority Data
Dec. 17, 2019 (FR) 19/14616

(51) Int. Cl. B32B 17/10

(52) U.S. Cl. CPC B32B 17/10495; B32B 17/1055; B32B 17/10871

(57) ABSTRACT

A pre-laminated opacifying assembly configured to cooperate with at least one transparent protection element, the pre-laminated opacifying assembly including a functional layer having a degree of opacity adapted to be modified, a bonding material attached on at least one face of the functional layer, the bonding material being configured to cooperate with the at least one transparent protection element so as to secure the at least one transparent protection element to the functional layer, the bonding material being configured to maintain adhesive properties for at least two firings such that a first firing secures the bonding material and the functional layer and a second firing secures the bonding material and the at least one transparent protection element.

### CROSS REFERENCE TO RELATED APPLICATIONS

This application is a National Stage of PCT Application No. PCT/EP2020/086819 filed on Dec. 17, 2020, which claims priority to French Patent Application No. 19/14616 filed on Dec. 17, 2019, the contents each of which are incorporated herein by reference thereto.

### TECHNICAL FIELD

The present invention concerns a pre-laminated opacifying assembly for a glazing and also a laminated opacifying glazing comprising said assembly.

### BACKGROUND

A laminated opacifying glazing comprises several layers which are secured together during a lamination process. The glazing comprises in particular a functional layer arranged to vary a degree of opacity of the glazing.

The glazing also comprises two panes disposed on either side of the functional layer so as to protect it and to generate a solid glazing.

Nonetheless, it may turn out to be difficult to transport the laminated opacifying glazing because the two panes constitute a significant weight with respect to the functional layer and may also include large dimensions. However, over long distances, it may be preferable to obtain panes locally rather than transporting the complete glazing.

However, the functional layer which is very fragile is more difficult to transport alone. Also, in the case where the functional layer is transported alone, the lamination may not be carried out with the functional layer alone, but with at least one suitable bonding material and provided with a power supply and electrical control. Moreover, this lamination must be carried out at the receiving location, which requires tools, specific equipment, a suitable environment and special skills, requiring heavy investment.

Finally, to add additional functionalities to the opacifying glazing, it is necessary to laminate other devices, such as printed circuits, lighting devices, heating devices, sensors, screens, etc. These devices are very difficult to laminate.

The present invention aims at solving all or part of the aforementioned drawbacks.

### BRIEF SUMMARY

To this end, the present invention concerns a pre-laminated opacifying assembly configured to cooperate with at least one transparent protection element, the pre-laminated opacifying assembly comprising: a functional layer having a degree of opacity adapted to be modified, a bonding material attached on at least one face of the functional layer, the bonding material being configured to cooperate with the at least one transparent protection element so as to secure the at least one transparent protection element to the functional layer, the bonding material being configured to maintain adhesive properties for at least two firings such that a first firing secures the bonding material and the functional layer and a second firing secures the bonding material and the at least one transparent protection element.

This arrangement allows the pre-laminated opacifying assembly to be stored and/or transported before securing the at least one transparent protection element. It is thus possible to initially produce pre-laminated opacifying assemblies which may be delivered as such as semi-finished products.

It is also not necessary to add a new layer of glue when securing the at least one transparent protection element since the bonding material maintains its adhesive properties.

According to an aspect of the invention, the at least one transparent protection element is a pane, preferably made of glass. Alternatively, the transparent protection element may be made of a synthetic material such as plastic.

According to an aspect of the invention, the bonding material is configured to melt according to determined temperature conditions.

According to an aspect of the invention, the functional layer comprises a connector configured to be connected to an outer element for varying the degree of opacity adapted to output a variable supply power.

According to an aspect of the invention, the bonding material has an outer surface configured to cooperate with the at least one transparent protection element, the bonding material comprising an outer portion extending from the outer surface. The outer portion is configured to maintain its molecular arrangement during the first firing. The bonding material should not undergo irreversible transformation at the level of the arrangement of its molecules.

In other words, during the first firing, the outer portion initiates a partial molecular entanglement with the aim of facilitating adhesion during the second firing. In particular, the outer portion corresponds to a determined thickness of bonding material extending from the outer surface towards the functional layer.

The exterior of the pre-laminated opacifying assembly has a granular and translucent appearance at the end of the first firing. This means that the bonding material is able to undergo the second firing to be secured to the at least one transparent protection element without adding a layer of glue.

According to an aspect of the invention, the outer portion of the bonding material is configured to be further transformed during the second firing.

Thus, the pre-laminated opacifying assembly constitutes a stable assembly and the second firing may be carried out several days after the first firing, which makes it possible to transport the pre-laminated opacifying assembly between the two firings yet without preventing performing the second firing. The outer portion also seals the pre-laminated opacifying assembly.

According to an aspect of the invention, the bonding material is attached on the two faces of the functional layer, each face being configured to be disposed opposite a corresponding transparent protection element.

This arrangement facilitates adding the two transparent protection elements during the second firing since two respective locations are provided to accommodate them opposite the two corresponding faces of the functional layer.

When the pre-laminated opacifying assembly is delivered as a semi-finished product, it is thus quick to add the two transparent protection elements to obtain a final product, without having to make heavy investments in terms of equipment and advanced studies in terms of process management.

The present invention also concerns a pre-laminated wrapped entity comprising a pre-laminated opacifying assembly and two protection layers attached on either side of the pre-laminated opacifying assembly on the outer surface.

The pre-laminated wrapped entity may be easily transported. The stacking of protection layers on the outer portion improves the strength of the assembly and facilitates the transport of the pre-laminated opacifying assembly.

Preferably, the protection layers are metallic layers and in particular aluminum layers. The pre-laminated wrapped entity constitutes therefore a semi-finished product which may be stored and transported without risk of degradation.

The packaging by protective layers guarantees the performance of the final glazing because the pre-laminated opacifying assembly is kept under specific conditions: humidity control, protection against radiation.

According to an aspect of the invention, the bonding material includes the functional layer.

In other words, the functional layer is encapsulated in the bonding material, i.e. comprised in a matrix constituted by the bonding material. This arrangement makes it possible to protect the functional layer so as to facilitate its transport.

According to an aspect of the invention, the bonding material comprises a transparent thermoplastic element.

This arrangement makes it possible to carry out several firings while maintaining the texture of the bonding material. Preferably, the thermoplastic element has properties of thermal insulation and/or filtering of incident rays such as infrared and/or UV.

According to an aspect of the invention, the functional layer may comprise an additional layer having properties of thermal insulation and/or filtering of incident rays such as infrared and/or UV.

According to an aspect of the invention, the functional layer comprises a state-changing opacifying film and a monitoring device disposed at least partially opposite the state-changing opacifying film.

The monitoring device may comprise at least one touch-sensitive control able to be used through the at least one transparent protection element. In other words, the touch-sensitive control operates by manual interaction on the transparent protection element opposite said touch-sensitive control. In particular, the monitoring device may comprise at least one sensor, for example a brightness sensor.

According to an aspect of the invention, the monitoring device is comprised in a monitoring system of the pre-laminated opacifying assembly, the monitoring system being configured to vary a degree of opacity of the state-changing opacifying film.

The pre-laminated opacifying assembly is thus a complete system in the way that it comprises integrated control means in addition to the means for varying the degree of opacity.

According to an aspect of the invention, the monitoring system comprises an electronic control component or an electronic circuit configured to be connected to a connector of the state-changing opacifying film.

According to an aspect of the invention, the electronic circuit is a printed circuit. According to an aspect of the invention, the electronic circuit comprises the control device.

According to an aspect of the invention, the pre-laminated opacifying assembly comprises a heating element configured to defrost the at least one transparent protection element when the at least one transparent protection element is secured to the bonding material.

This arrangement makes it possible to integrate an additional function into the pre-laminated opacifying assembly.

According to one aspect of the invention, the heating element is comprised in the functional layer and in particular in the control device. According to one variant, the heating element is separate from the control device and is connected to the control device.

According to an aspect of the invention, the pre-laminated opacifying assembly comprises a lighting device.

Preferably, the lighting device comprises at least one light source, such as a LED.

According to one aspect of the invention, the lighting device is comprised in the functional layer and in particular in the control device. According to one variant, the lighting device is separate from the control device and is connected to the control device.

According to an aspect of the invention, the functional layer comprises an information display device.

The information display device comprises a screen, such as a flexible screen, or a light-emitting display. Preferably, the information display device is configured to be transparent in an idle operation mode or when turned off.

According to an aspect of the invention, the pre-laminated opacifying assembly comprising at least one photovoltaic element configured to capture an incident ray through the at least one transparent protection element when the at least one transparent protection element is secured to the bonding material.

Preferably, the at least one photovoltaic element is transparent.

According to an aspect of the invention, the photovoltaic element is comprised in the functional layer and in particular in the control device. According to one variant, the photovoltaic element is separate from the control device and connected to the control device.

According to an aspect of the invention, the functional layer and the bonding material are secured together so as to generate a surface assembly having a slice defining an outer outline, the pre-laminated opacifying assembly comprising a seal attached on at least one portion of the slice.

This arrangement makes it possible to protect the pre-laminated opacifying assembly against the external environment. Preferably, the seal comprises a synthetic polymer. In particular, the seal is attached on the entire outline.

According to an aspect of the invention, the monitoring system comprises an outer bonding element passing through the seal, the outer bonding element being configured to be connected to an energy source such as a battery or a current source.

According to an aspect of the invention, the pre-laminated opacifying assembly is obtained by lamination.

This arrangement allows the securing of the elements constituting the assembly so as to constitute a robust assembly which is easy to transport. According to an aspect of the invention, the lamination consists of complexing and firing.

The present invention also concerns a laminated opacifying glazing comprising a pre-laminated opacifying assembly as described above and the at least one transparent protection element.

According to an aspect of the invention, the at least one transparent protection element is assembled to the pre-laminated opacifying assembly by lamination. Thus, the pre-laminated opacifying assembly may be easily secured to the at least one transparent protection element without being necessary to add a new adhesive layer such as a layer of glue.

The present invention also concerns a method for manufacturing a pre-laminated opacifying assembly as described above, comprising the following steps: positioning the bonding material on at least one face of the functional layer, carrying out the first firing securing the bonding material and the functional layer according to a firing temperature below a limit value so as to obtain a partial molecular entanglement of the bonding material.

According to an aspect of the invention, the limit value of the firing temperature is 100° C. According to an aspect of the invention, the first firing is carried out under a vacuum comprised between 0 and -980 mbar or using a heating press configured to apply a pressure of up to one bar.

Preferably, the vacuum is obtained by a vacuum bag. The press-firing may be carried out flat or according to a guide configured to impart an at least partially domed shape to the pre-laminated opacifying assembly.

The various non-incompatible aspects defined hereinbefore may be combined.

### BRIEF DESCRIPTION OF THE FIGURES

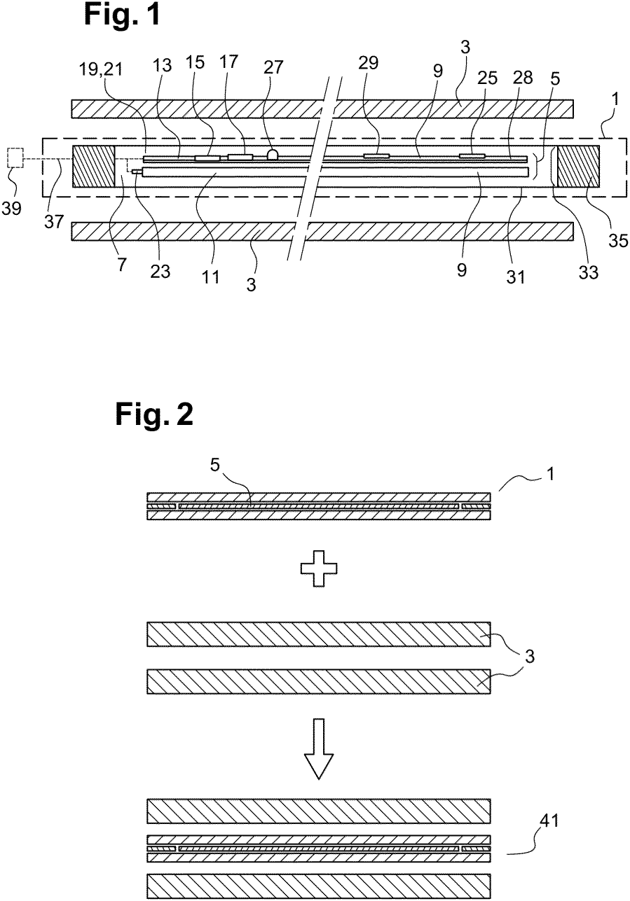

The invention will be better understood with the aid of the detailed description that is disclosed hereinbelow with reference to the appended drawings.

[FIG. 1] is a schematic sectional view of a glazing comprising a pre-laminated opacifying assembly.

[FIG. 2] is a schematic sectional view of the glazing comprising the pre-laminated opacifying assembly when being mounted.

### DETAILED DESCRIPTION

In the following detailed description of the figures defined hereinabove, same elements or the elements filling identical functions may keep the same reference numerals so as to simplify understanding of the invention.

As illustrated in FIG. 1, the pre-laminated opacifying assembly 1 is configured to cooperate with at least one transparent protection element 3, and in particular two transparent protection elements. The pre-laminated opacifying assembly 1 comprises a functional layer 5 having a degree of opacity adapted to be modified and a bonding material 7.

The at least one protection element 3 may be a pane, preferably made of glass, Alternatively, the transparent protection element 3 may be made of a synthetic material such as plastic.

The bonding material 7 is attached on each face 9 of the functional layer 5, the bonding material 7 being configured to cooperate with the transparent protection elements 3 so as to secure them to the functional layer 5.

The bonding material 7 is configured to melt according to determined temperature conditions. The bonding material 7 comprises a transparent thermoplastic element. The thermoplastic element has properties of thermal insulation and/or filtering of incident rays such as infrared and/or UV.

Each face 9 of functional layer 5 is configured to be disposed opposite a corresponding transparent protection element 3.

The functional layer 5 comprises a state-changing opacifying film 11 and a monitoring device 13, which may be a film or a thin element, disposed at least partially opposite the state-changing opacifying film 11.

The monitoring device 13 may comprise a touch-sensitive control 15 able to be used through the at least one transparent protection element 3. In other words, the touch-sensitive control 15 operates by manual interaction on the transparent protection element 3 opposite said touch-sensitive control 15. The monitoring device 13 may comprise a sensor 17, for example a brightness sensor.

The monitoring device 13 is comprised in a monitoring system 19 of the pre-laminated opacifying assembly 1, the monitoring system 19 being configured to vary a degree of opacity of the state-changing opacifying film 11.

The monitoring system 19 may comprise an electronic circuit 21 configured to be connected to a connector 23 of the state-changing opacifying film 11.

Alternatively, the connector 23 is configured to be connected to an outer element for varying the degree of opacity that is adapted to output variable supply power.

When present, the electronic circuit 21 is a printed circuit and the electronic circuit 21 comprises the monitoring device 13.

The monitoring device 13 may comprise a heating element 25 configured to defrost the corresponding transparent protection element 3. The monitoring device 13 may also comprise a lighting device 27, such as a LED, a diode, a phosphorescent element.

The monitoring device 13 may comprise an information display device 28. The information display device 28 comprises a screen, such as a flexible screen, or an electroluminescent display. The information display device 28 may be configured to be transparent in an idle operation mode or when turned off.

The monitoring device 13 may comprise a photovoltaic element 29 configured to capture an incident ray through at least one transparent protection element 3. The at least one photovoltaic element 29 is transparent.

The functional layer 5 and the bonding material 7 are secured together so as to generate a surface assembly 31. By surface assembly 31, it should be understood an assembly having a flat and/or curved shape, that is to say with a small thickness compared to its other dimensions.

The surface assembly 31 has a slice 33 defining an outer outline, the pre-laminated opacifying assembly 1 comprising a seal 35 attached on at least a portion of the slice 33, and in particular to the entire outline. The seal 35 comprises a synthetic polymer.

The monitoring system 19 may comprise an outer bonding element 37 passing through the seal 35, the outer bonding element 37 being configured to be connected to a power source 39 such as a battery or a current source.

The bonding material 7 includes the functional layer 5. In other words, the functional layer 5 is encapsulated in the bonding material 7, that is to say comprised in a matrix constituted by the bonding material 7.

As illustrated in FIG. 2, the pre-laminated opacifying assembly 1 is obtained by lamination, the lamination consisting of complexing and firing.

The bonding material 7 is configured to maintain adhesive properties for at least two firings so that a first firing secures the bonding material 7 and the functional layer 5 and a second firing secures the bonding material 7 and the transparent protection elements 3.

Thus, a laminated opacifying glazing 41 comprises the pre-laminated opacifying assembly 1 and the two transparent protection elements 3.

The two transparent protection elements 3 are assembled to the pre-laminated opacifying assembly 1 by lamination, that is to say complexing and firing. Thus, the pre-laminated opacifying assembly 1 may be easily secured to the transparent protection elements 3 during a second lamination following the manufacture of the pre-laminated opacifying assembly 1 without being necessary to add a new adhesive layer such as a layer of glue.

This arrangement allows the pre-laminated opacifying assembly 1 to be stored and/or transported before securing the transparent protection elements. It is therefore possible to produce initially pre-laminated opacifying assemblies 1 which may be delivered as such as semi-finished products.

More specifically, the bonding material 7 has an outer surface configured to cooperate with the transparent protection elements 3, the bonding material 7 comprising an outer portion extending from the outer surface.

The outer portion is configured to maintain its molecular arrangement during the first firing. The bonding material 7 should not undergo irreversible transformation at the level of the arrangement of its molecules.

In other words, during the first firing, the outer portion initiates a partial molecular entanglement with the aim of facilitating adhesion during the second firing. The outer portion corresponds to a determined thickness of bonding material extending from the outer surface towards the functional layer 5.

The exterior of the pre-laminated opacifying assembly has a granular and translucent appearance at the end of the first firing. This means that the bonding material is able to undergo the second firing to be secured to the at least one transparent protection element without adding a layer of glue.

The outer portion of the bonding material is configured to be further transformed during the second firing.

For the transport, a pre-laminated wrapped entity comprising a pre-laminated opacifying assembly and two protection layers attached on either side of the pre-laminated opacifying assembly on the outer surface, is produced.

The protection layers are metallic layers and in particular aluminum layers. The pre-laminated wrapped entity constitutes therefore a semi-finished product which may be stored and transported without risk of degradation.

With regard to the method of manufacturing the pre-laminated opacifying assembly 1 as described above, the following steps are carried out: positioning the bonding material 7 on the faces of the functional layer 5 and carrying out the first firing for securing the bonding material 7 and the functional layer 5 according to a firing temperature below 100° C.

The first firing is carried out under a vacuum comprised between 0 and -980 mbar or using a heating press configured to apply a pressure of up to one bar.

The vacuum is obtained by a vacuum bag. The press-firing may be carried out flat or according to a guide configured to impart an at least partially domed shape to the pre-laminated opacifying assembly.

It goes without saying that the invention is not limited to the sole embodiment described hereinabove as example, it encompasses on the contrary all variants thereof.

1. A pre-laminated opacifying assembly configured to cooperate with at least one transparent protection element, the pre-laminated opacifying assembly comprising:
a functional layer having a degree of opacity adapted to be modified, and
a bonding material attached on at least one face of the functional layer, the bonding material being configured to cooperate with the at least one transparent protection element so as to secure the at least one transparent protection element to the functional layer, the bonding material being configured to maintain adhesive properties for at least two firings such that a first firing secures the bonding material and the functional layer and a second firing secures the bonding material and the at least one transparent protection element.

2. The pre-laminated opacifying assembly according to claim 1, wherein the bonding material is attached on the-two faces of the functional layer, each face of the two faces being configured to be disposed opposite a corresponding transparent protection element.

3. The pre-laminated opacifying assembly according to claim 1, wherein the bonding material includes the functional layer.

4. The pre-laminated opacifying assembly according to claim 1, wherein the bonding material comprises a transparent thermoplastic element.

5. The pre-laminated opacifying assembly according to claim 1, wherein the functional layer comprises a state-changing opacifying film and a monitoring device disposed at least partially opposite the state-changing opacifying film.

6. The pre-laminated opacifying assembly according to claim 5, wherein the monitoring device is comprised in a monitoring system of the pre-laminated opacifying assembly, the monitoring system being configured to vary a degree of opacity of the state-changing opacifying film.

7. The pre-laminated opacifying assembly according to claim 6, wherein the monitoring system comprises a control electronic component or an electronic circuit configured to be connected to a connector of the state-change opacifying film.

8. The pre-laminated opacifying assembly according to claim 1, comprising a heating element configured to defrost the at least one transparent protection element (3)-when the at least one transparent protection element is secured to the bonding material.

9. The pre-laminated opacifying assembly according to claim 1, wherein the functional layer and the bonding material are secured together so as to generate a surface assembly having a slice defining an outer outline, the pre-laminated opacifying assembly comprising a seal attached on at least one portion of the slice.

10. A laminated opacifying glazing comprising a pre-laminated opacifying assembly according to claim 1 and the at least one transparent protection element.

11. A method for manufacturing a pre-laminated opacifying assembly according claim 1, comprising the following steps:
positioning the bonding material on at least one face of the functional layer,
carrying out the first firing for securing the bonding material and the functional layer according to a firing temperature below a limit value so as to obtain a partial molecular entanglement of the bonding material.

12. The manufacturing method according to claim 11, wherein the limit value of the firing temperature is 100° C.

13. The manufacturing method according to claim 11, according to which the first firing is carried out under a vacuum comprised between 0 and -980 mbar or using a heating press configured to apply a pressure of up to one bar.

14. The pre-laminated opacifying assembly according to claim 2, wherein the bonding material includes the functional layer.

15. The pre-laminated opacifying assembly according to claim 14, wherein the bonding material comprises a transparent thermoplastic element.

16. The pre-laminated opacifying assembly according to claim 15, wherein the functional layer comprises a state-changing opacifying film and a monitoring device disposed at least partially opposite the state-changing opacifying film.

17. The pre-laminated opacifying assembly according to claim 16, wherein the monitoring device is comprised in a monitoring system of the pre-laminated opacifying assembly, the monitoring system being configured to vary a degree of opacity of the state-changing opacifying film.

18. The pre-laminated opacifying assembly according to claim 17, wherein the monitoring system comprises a control electronic component or an electronic circuit configured to be connected to a connector of the state-change opacifying film.

19. The pre-laminated opacifying assembly according to claim 18, comprising a heating element configured to defrost the at least one transparent protection element when the at least one transparent protection element is secured to the bonding material.

20. The pre-laminated opacifying assembly according to claim 19, wherein the functional layer and the bonding material are secured together so as to generate a surface assembly having a slice defining an outer outline, the pre-laminated opacifying assembly comprising a seal attached on at least one portion of the slice.
